(19) United States
(12) Patent Application Publication
(10) Pub. No.: US 2010/0013333 A1
(43) Pub. Date: Jan. 21, 2010

(54) MAGNETIC RADIAL BEARING HAVING PERMANENT-MAGNET GENERATED MAGNETIC BIAS, AND A MAGNETIC BEARING SYSTEM HAVING A MAGNETIC RADIAL BEARING OF THIS TYPE

(75) Inventor: Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/505,922

(22) Filed: Jul. 20, 2009

(30) Foreign Application Priority Data
Jul. 21, 2008 (EP) EP08013098

(51) Int. Cl. H02K 7/09

(52) U.S. Cl. 310/90.5

(57) ABSTRACT

A magnetic radial bearing and a magnetic bearing system for non-contact support of a rotor shaft are disclosed. The magnetic radial bearing for non-contact support of a rotor shaft includes a rotating-field machine stator with a plurality of stator slots distributed in a circumferential direction, and stator teeth with radial ends arranged between adjacent stator slots. The number of stator teeth is equal to the number of stator slots. A three-phase stator winding is wound around the stator slots for producing a rotating magnetic field. An axially extending permanent magnet in form of a strip or plate is arranged at the radial end of each stator tooth, wherein permanent magnets that are adjacently arranged in the circumferential direction have alternating opposing radial magnetization directions.

### CROSS-REFERENCES TO RELATED APPLICATIONS

This application claims the priority of European Patent Application, Serial No. EP 08013098, filed Jul. 21, 2008, pursuant to 35 U.S.C. 119(a)-(d), the content of which is incorporated herein by reference in its entirety as if fully set forth herein.

### BACKGROUND OF THE INVENTION

The invention relates to a magnetic radial bearing for non-contact support of a rotor shaft, with the magnetic radial bearing having a rotating-field machine stator with a number n of stator slots, which are distributed in a circumferential direction, and an equal number n of stator teeth between them. The stator slots are wound with a three-phase stator winding that produce a rotating magnetic field. Bearings such as these are also referred to as active magnetic bearings or active magnet bearings. The invention also relates to a magnetic bearing system which has a magnetic radial bearing of this type and a three-phase controller for rotating-field excitation. The three-phase controller is preferably a converter.

The following discussion of related art is provided to assist the reader in understanding the advantages of the invention, and is not to be construed as an admission that this related art is prior art to this invention.

Active magnetic bearings are intended for non-contact, wear-free support of a rotor shaft of a rotating machine. The machines under consideration may have a mass of more than one ton and an electrical rating of more than 500 kW, in particular of several Megawatts. Machines of this type are, for example, electric motors, generators, turbomachines, compressors, pumps and the like. They may have a maximum rotation speed of 4000 rpm or more. During use, an air gap, preferably in the range from 0.3 mm to 0.5 mm, is maintained between the magnetic radial bearing and the rotor shaft to be supported.

It would be desirable and advantageous to provide an improved device for supporting a rotor shaft, which obviates prior art shortcomings and has a magnetic radial bearing of a particularly simple construction.

It would also be desirable to provide a magnetic bearing system with a magnetic radial bearing of this type.

### SUMMARY OF THE INVENTION

To ensure clarity, it is necessary to establish the definition of several important terms and expressions that will be used throughout this disclosure. The term “radial” refers to a direction toward and away from a rotation axis of the rotor shaft that is held. The term “axial” refers to a direction parallel to the rotation axis. The term “in the circumferential direction” means tangential directions around the rotation axis of the rotor shaft. The bearing of the rotor shaft during use corresponds to the rotation axis of the rotor shaft, actually of a physical rotation axis or rotational axis of symmetry of the magnetic radial bearing.

According to one aspect of the invention, a magnetic radial bearing for non-contact support of a rotor shaft includes a rotating-field machine stator having a plurality of stator slots distributed in a circumferential direction, and stator teeth with radial ends arranged between adjacent stator slots, with a number of stator teeth equal to a number of stator slots. The magnetic radial bearing further includes a three-phase stator winding wound around the stator slots for producing a rotating magnetic field, and permanent magnets in form of a strip or plate and extending in an axial direction. A corresponding permanent magnet is arranged at the radial end of each stator tooth, with permanent magnets arranged adjacently in the circumferential direction having alternating opposing radial magnetization directions.

The benefit of the magnetic radial bearing according to the invention lies in the simple physical design of the permanent-magnet magnetic bias. Radially aligned magnetic poles are created along the permanent magnets, which are arranged in the circumferential direction, with the polarity of the magnetic poles alternating between a North direction and a South direction. The permanent magnetic fields are here either amplified or attenuated by the rotating electromagnetic field, which is superimposed in the same radial direction, of the three-phase stator winding. This makes it possible to adjust the rotating electromagnetic field to achieve a specific, radial magnetic force on the ferromagnetic rotor shaft to be supported.

In a simplest case, the permanent magnets, which are in the form of strips or plates, may be adhesively bonded to corresponding radial ends of the stator teeth. Alternatively, two axially extending, tangentially opposite slots may be formed at the radial end of each stator tooth, with the optionally magnetized permanent magnets then axially inserted into these slots.

According to another advantageous feature of the present invention, the permanent magnets may have a rectangular cross section or a cross section in the form of an annular segment. In the latter case, because of their curved external shape, the permanent magnets can be fitted flush to the respective radial end of the stator teeth.

If a maximum radial distance of the permanent magnets from a center of the rotor shaft is less than a minimum radial distance of the stator slots from the center of the rotor shaft, then this once again simplifies the design of the radial bearing according to the invention.

According to another advantageous feature of the present invention, a radial thickness of the permanent magnets can be in a range of 0.1 to 0.5 times a radial depth of the stator slots. A typical value is in a range of 0.3 times.

According to another advantageous feature of the present invention, a number of pole pairs pᵥ of the permanent magnetic field and a number of pole pairs p_{D} of the three-phase rotating field differ by the value 1. A magnetic two-pole field wave, which acts in the circumferential direction and regulates the orientation of the rotor shaft, can advantageously be adjusted with a predetermined phase angle of the applied rotating field. The number of pole pairs pᵥ of the permanent magnetic field is directly predetermined by the number of permanent magnets which are attached to the inside of the stator. The number of pole pairs p_{D} of the three-phase rotating field can be predetermined by a corresponding three-phase winding of the rotating-field machine stator.

According to another advantageous feature of the present invention, the three-phase stator winding may be a three-phase winding with a number of holes q=⅖. The number of holes can hereby be the quotient of the number of stator slots divided by the number of phases and the number of electromagnetic poles which are produced by the rotating field.

According to another advantageous feature of the present invention, the rotating-field machine stator may have twelve stator slots and twelve permanent magnets. The permanent magnetic field then has six pole pairs pᵥ, and the three-phase rotating field has five pole pairs p_{D} under corresponding excitation by a connected three-phase controller. A magnetic radial bearing of this type has advantageously a physically very simple and extremely compact design.

According to another advantageous feature of the present invention, the ratio of an internal diameter of the magnetic radial bearing to its axial length may range from 0.3 to 2, preferably in a range from 0.8 to 1.25. In special applications, the ratio may also have lower values, for example 0.2, or higher values, for example 3.

The object of the invention can also be achieved by a magnetic bearing system having a magnetic radial bearing according to the invention and having a three-phase controller for exciting the rotating magnetic field in the stator winding.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a rotating machine having a magnetic radial bearing for non-contact support of a rotor shaft,

FIG. 2 shows a circuit diagram of a magnetic bearing system having a three-phase controller in the form of a converter, and having a downstream, magnetic radial bearing,

FIG. 3 shows an axial section through an example of a magnetic radial bearing according to the invention, and

FIG. 4 shows an enlarged illustration of the upper part, as shown in FIG. 3, of the magnetic radial bearing according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

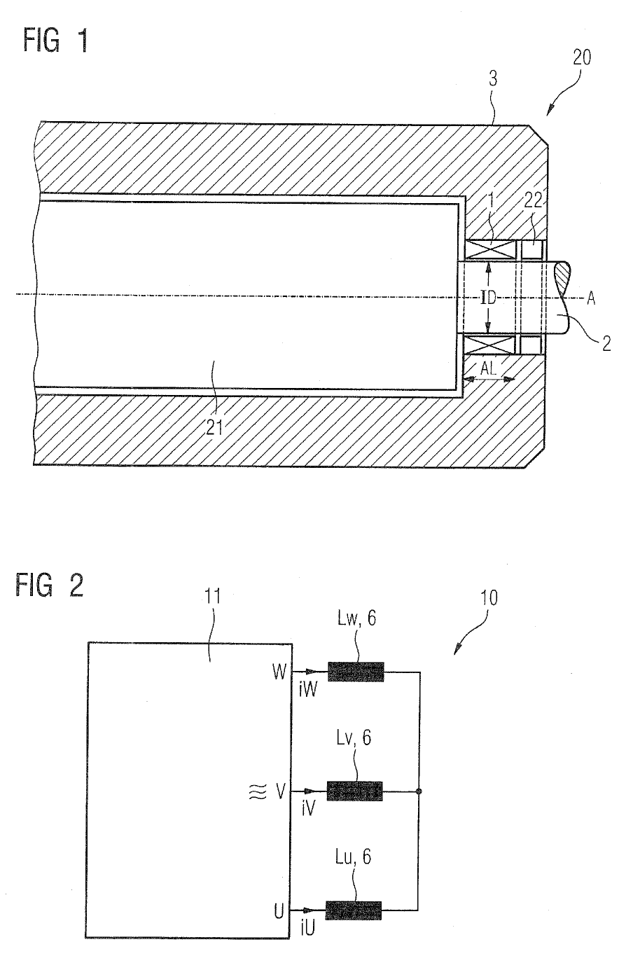

Turning now to the drawing, and in particular to FIG. 1, there is shown a rotating machine 20 having a magnetic radial bearing 1 for non-contact support of a rotor shaft 2. The reference symbol A denotes a rotation axis of the rotor shaft 2, AL denotes an axial length of the magnetic radial bearing 1, and ID denotes an internal diameter of the radial bearing 1. By way of example, the illustrated rotating machine 20 is an electric motor having a rotor core 21 and a rotating-field machine stator which is annotated with the reference symbol 3. The rotating machine 20 may furthermore be a pump, a compressor, a spindle or some other rotating machine. Currently preferred is the implementation of the rotating machines 20 as turbomachines. The reference symbol 22 denotes a so-called holding bearing, which holds the rotor shaft 2 when there is no electrical power supply for the magnetic radial bearing 1.

FIG. 2 shows a magnetic bearing system 10 having a three-phase controller 11, which is in the form of a converter, and having a magnetic radial bearing 1 which is connected on the output side, with only the three coils Lu, Lv, Lw, by way of example of one stator winding 6 of the magnetic radial bearing 1 being illustrated, with respect to the circuitry. U, V, W are the phases of the three-phase controller 11, and iU, iV, iW denote the associated phase currents for rotating-field excitation.

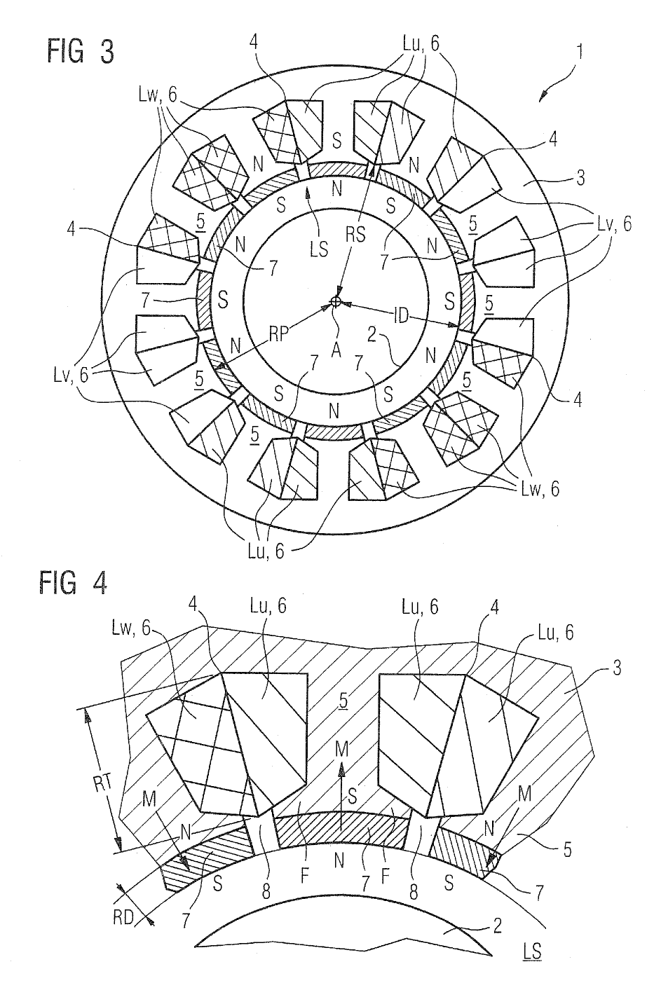

FIG. 3 shows an axial section through a magnetic radial bearing 1 according to the invention. The rotating-field machine stator, which is annotated with the reference symbol 3, is preferably a laminated core having a multiplicity of electrical laminates, which are arranged axially one behind the other, in order to reduce the eddy current losses which occur during operation of the magnetic bearing 1. The illustrated magnetic radial bearing 1 has, by way of example, twelve stator slots 4 into which, by way of example, a three-phase stator winding 6 is introduced, with the associated three-phase coils Lu, Lv, Lw. The slots are wound as fractional-pitch windings, for example, in order to set a number of pole pairs p_{D}. A “fractional-pitch” stator winding or three-phase winding means that two or more phase winding sections of a coil Lu, Lv, Lw can be introduced together with other phase winding sections into one common slot. The reference symbol 5 denotes the stator teeth which are located between the stator slots 4.

According to the invention, a permanent magnet 7 in form of a strip or plate and extending in an axial direction is here arranged at each radial end of the stator teeth 5. The permanent magnets 7 have a radial magnetization direction M which alternates in the circumferential direction. This is illustrated by an arrow pointing from a magnetic North pole N to a magnetic South pole S of the respective permanent magnet 7. The rotor shaft 2 which rotates about a rotation axis A is illustrated in cross-section in the center of the illustrated magnetic radial bearing 1. An air gap LS is disposed between the rotor shaft 2 and the radial inner face of the magnetic radial bearing 1. This air gap is about 0.3 mm to 0.5 mm for a correct magnetic support. The example in FIG. 3 also shows that a maximum radial distance RP between the permanent magnet 7 is less than a minimum radial distance RS between the stator slots 4.

FIG. 4 shows in an enlarged view the upper part of the rotating-field machine stator 3 illustrated in FIG. 3. This illustration shows the permanent magnet 7 in form of a cross-sectional annular segment. The geometry of the radial outer contour of the permanent magnets 7 then matches the geometry of the radial inner contour of the stator teeth 5. In this case, a radial thickness RD of the illustrated permanent magnets 7 is in the region of 0.1 to 0.5 times a radial depth RT of the stator slots 4. In the present example, the radial thickness RD is about 0.3 times. For better field guidance, the stator teeth 5 are widened tangentially in the radial direction with respect to the rotation axis A. The stator slots 5 form a foot F in this area, which is adjacent to the permanent magnets 7. An axially extending slot or gap 8 remains between the permanent magnets 7 and between two respectively adjacent stator teeth 5. This can likewise optionally be filled with a preferably non-magnetic material, for example with a plastic. This improves the mechanical attachment of the permanent magnets 7 on the radial inner face of the rotating-field machine stator 3.

The magnetic radial bearing 1 according to the invention has a three-phase winding 6 with a number of holes q=⅖. This results from the number n of twelve for the permanent magnets 7, which produce a permanent magnetic field with a number of pole pairs pᵥ of six, and from the three-phase winding 6 with a correspondingly fractional-pitch distribution of the respective phase winding sections Lu, Lv, Lw with a number of pole pairs p_{D} of five. In other words, an electromagnetic ten-pole magnetic field, whose rotation direction around the rotation axis A can be adjusted, is produced with three-phase excitation of the three-phase winding 6 by means of a three-phase controller 11.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A magnetic radial bearing for non-contact support of a rotor shaft, comprising:
a rotating-field machine stator having a plurality of stator slots distributed in a circumferential direction, and stator teeth with radial ends arranged between adjacent stator slots, with a number of stator teeth equal to a number of stator slots,
a three-phase stator winding wound around the stator slots for producing a rotating magnetic field, and
axially extending permanent magnets in form of a strip or plate and arranged at the radial end of each stator tooth, with permanent magnets arranged adjacently in the circumferential direction having alternating opposing radial magnetization directions.

2. The magnetic radial bearing of claim 1, wherein the permanent magnets have a rectangular cross section or a cross section in the form of an annular segment.

3. The magnetic radial bearing of claim 1, wherein a maximum radial distance of the permanent magnets from a center of the rotor shaft is less than a minimum radial distance of the stator slots from the center of the rotor shaft.

4. The magnetic radial bearing of claim 1, wherein a radial thickness of the permanent magnets is between about 0.1 times and about 0.5 times a radial depth of the stator slots.

5. The magnetic radial bearing of claim 1, wherein a number of pole pairs of a magnetic field produced by the permanent magnets and a number of pole pairs of the three-phase rotating field differ by a value of 1.

6. The magnetic radial bearing of claim 5, wherein the three-phase stator winding has a number of holes q=⅖.

7. The magnetic radial bearing of claim 6, wherein the rotating-field machine stator has twelve stator slots and twelve permanent magnets, so that the magnetic field produced by the permanent magnets has six pole pairs, and wherein the three-phase rotating field has five pole pairs when excited by a connected three-phase controller.

8. A magnetic bearing system having a magnetic radial bearing for non-contact support of a rotor shaft, the magnetic radial bearing comprising:
a rotating-field machine stator having a plurality of stator slots distributed in a circumferential direction, and stator teeth with radial ends arranged between adjacent stator slots, with a number of stator teeth equal to a number of stator slots;
a three-phase stator winding wound around the stator slots for producing a rotating magnetic field;
axially extending permanent magnets in form of a strip or plate and arranged at the radial end of each stator tooth, with permanent magnets arranged adjacently in the circumferential direction having alternating opposing radial magnetization directions; and
a three-phase controller for exciting the rotating magnetic field in the stator winding.
